(19) United States
(12) Patent Application Publication
(10) Pub. No.: US 2012/0166112 A1
(43) Pub. Date: Jun. 28, 2012

(54) ELECTRONIC DEVICE AND VIBRATION TESTING METHOD THEREOF

(75) Inventors: CHUNG-JEN WANG, Tu-Cheng (TW); LI-SHENG SHU, Shenzhen (CN); TSUNG-JEN CHUANG, Tu-Cheng (TW); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/071,534

(22) Filed: Mar. 25, 2011

(30) Foreign Application Priority Data
Dec. 27, 2010 (CN) 201010607370.3

(51) Int. Cl. G06F 19/00

(52) U.S. Cl. 702/56

(57) ABSTRACT

The disclosure relates to an electronic device with vibration function and a vibration testing method utilized to test the electronic device. The electronic device includes a motor and a storage unit for storing data of a relationship between electrical currents of the motor and vibration frequencies of the motor. The method includes: measuring an electrical current of the motor when the motor vibrates, reading the stored relationship from the storage unit, and acquiring the vibration frequency of the motor corresponding to the measured current according to the measured current and the stored relationship.

### BACKGROUND

1. Technical Field

The disclosure relates to induced vibration technology and, more particularly, to an electronic device with vibration function and a vibration testing method utilized to test the electronic device.

2. Description of Related Art

One method of testing vibration of a motor is performed by sight, which is susceptible to human error.

Therefore, what is needed is an electronic device with vibration function and a vibration testing method utilized to test the electronic device to overcome the limitations described.

### BRIEF DESCRIPTION OF THE DRAWINGS

FIG. 1 is a block diagram of an electronic device with vibration function in accordance with an exemplary embodiment.

FIG. 2 is a schematic diagram of data of a relationship between electrical currents and vibration frequencies of a motor, which is stored in the electronic device of FIG. 1.

FIG. 3 is a flowchart of a vibration testing method utilized to test an electronic device such as, for example, that of FIG. 1.

### DETAILED DESCRIPTION

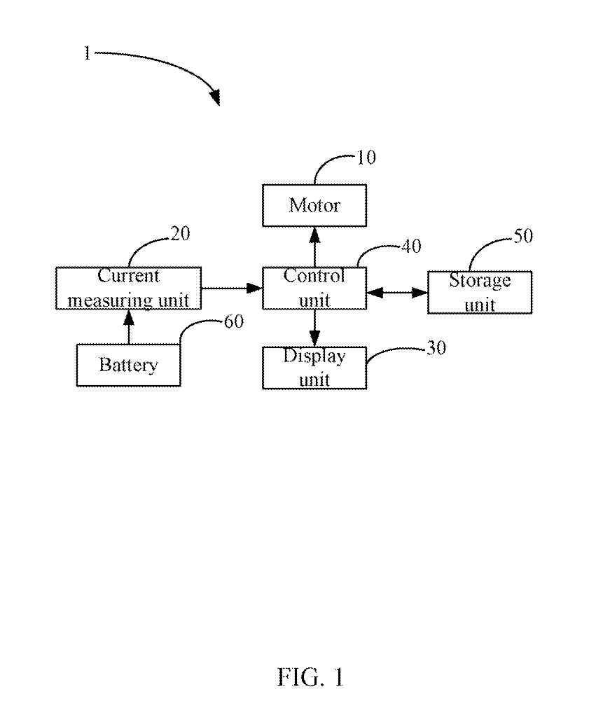

FIG. 1 is a block diagram of an electronic device with vibration function in accordance with an exemplary embodiment. The electronic device with vibration function (hereinafter “the device”) 1 includes a motor 10, a current measuring unit 20, a display unit 30, a control unit 40, a storage unit 50, and a battery 60. The control unit 20 is configured for controlling the device 1. The motor 10 is configured for generating a vibration. The display unit 30 is configured for displaying information.

The battery 60 is configured for supplying power to the device 1. For example, the battery 60 supplies power to the motor 10. When the battery 60 provides current to the motor 10, the motor 10 vibrates at a frequency according to a relationship between amount of currents and frequencies of vibration. For example, when the battery 60 provides a high current to the motor 10, the motor 10 vibrates at a high frequency, and when the battery 60 provides a low current to the motor 10, the motor 10 vibrates at a low frequency.

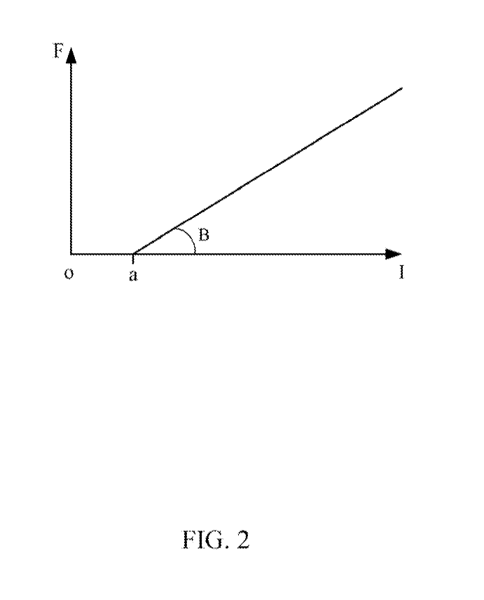

The storage unit 50 is configured for storing data of a relationship between electrical currents and vibration frequencies of the motor 10. For example, the storage unit 50 stores a relationship table between electrical currents of the motor and vibration frequencies of the motor 10 or a relationship function between electrical currents and vibration frequencies of the motor 10. As shown in FIG. 2, the storage unit 50 stores a relationship function, wherein the x-axis represents the electrical currents “I” of the motor 10, the y-axis represents the vibration frequencies “F” of the motor 10, and the relationship function is F=(tgB)(I−a), wherein “a” is a constant, “B” is an angle and “tgB” is also a constant, that is, the relationship between electrical currents and vibration frequencies of the motor 10 is a direct ratio.

The current measuring unit 20 is configured for measuring the electrical current of the motor 10 when the motor 10 vibrates. In the embodiment, the current measuring unit 20 is an ammeter. When the motor 10 vibrates in response to user input, the control unit 40 is configured to control the current measuring unit 20 to measure the current of the motor 10 and read the stored relationship from the storage unit 50, and acquire a vibration frequency of the motor 10 corresponding to the measured current according to the measured current and the stored relationship. The control unit 40 is further configured for controlling the display unit 30 to display the acquired vibration frequency, therefore, a user may know a vibration state of the motor 10 in the device 1. If the frequency falls within a desired range then the motor 10 passes the test. If the frequency is outside the desired range then the motor 10 fails.

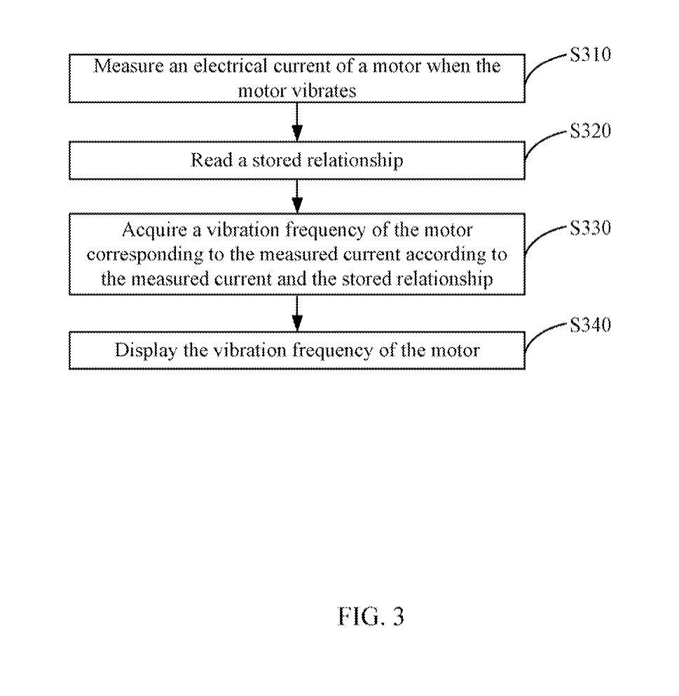

FIG. 3 is a flowchart of a vibration testing method utilized to test an electronic device such as, for example, that of FIG. 1. In step S310, when the motor 10 vibrates in response to user input, the current measuring unit 20 measures the electrical current of the motor 10. In step S320, the control unit 40 reads the stored relationship from the storage unit 50. In step S330, the control unit 40 acquires the vibration frequency of the motor 10 corresponding to the measured current according to the measured current and the stored relationship. In step S340, the display unit 30 displays the vibration frequency of the motor 10.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a motor;
a storage unit for storing data of a relationship between electrical currents of the motor and vibration frequencies of the motor;
a current measuring unit for measuring an electrical current of the motor when the motor vibrates; and
a control unit for controlling the current measuring unit to measure the electrical current of the motor and reading the stored relationship from the storage unit, and acquiring a vibration frequency of the motor corresponding to the measured current according to the measured current and the stored relationship when the motor vibrates.

2. The electronic device as recited in claim 1, further comprising a display unit for displaying the acquired vibration frequency of the motor.

3. The electronic device as recited in claim 1, wherein the relationship between electrical currents and vibration frequencies of the motor is a direct ratio.

4. The electronic device as recited in claim 1, wherein the current measuring unit is an ammeter.

5. A vibration testing method utilized to test an electronic device, wherein the electronic device comprises a motor and a storage unit for storing data of a relationship between electrical currents of the motor and vibration frequencies of the motor, the method comprising:
measuring an electrical current of the motor when the motor vibrates;
reading the stored relationship from the storage unit; and
acquiring the vibration frequency of the motor corresponding to the measured current according to the measured current and the stored relationship.

6. The vibration testing method as recited in claim 5, further comprising: displaying the acquired vibration frequency of the motor.

7. The vibration testing method as recited in claim 5, wherein the relationship between electrical currents and vibration frequencies of the motor is a direct ratio.
